(19) United States
(12) Patent Application Publication
(10) Pub. No.: US 2009/0101593 A1
(43) Pub. Date: Apr. 23, 2009

(54) PULSED POWER WATER TREATMENT

(76) Inventors: John Dresty, South Glastonbury, CT (US); David Alley, Haddam, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 12/271,218

(22) Filed: Nov. 14, 2008

Related U.S. Application Data
(63) Continuation-in-part of application No. 11/801,493, filed on May 9, 2007.
(60) Provisional application No. 60/799,162, filed on May 9, 2006.

(51) Int. Cl. C02F 1/50; C02F 101/00; C02F 1/02

(52) U.S. Cl. 210/748; 210/177; 210/758; 210/754; 210/759

(57) ABSTRACT

A method for providing biological control to a flow of water in a recirculating potable hot water system. In such a system, water is subjected to an initial chemical treatment using an oxidizing biocide such as chlorine dioxide or peracetic acid that rapidly kills biofilm and Legionella bacteria. This treatment is continued until existing Legionella bacteria and biofilm are controlled. Once the bacteria and biofilm are controlled the chemical treatment is stopped. Starting concurrently with the chemical treatment or at the termination of the chemical treatment, non-chemical water treatment is provided. The non-chemical water treatment maintains the water system in a condition which is free of Legionella bacteria and biofilm. Chemical water treatment may be repeated intermittently should it prove desirable or necessary.

### CROSS-REFERENCE TO RELATED APPLICATION

This application is a continuation-in-part application of U.S. patent application Ser. No. 11/801,493, filed May 9, 2007, which claims the benefit of U.S. provisional application No. 60/799,162, filed May 9, 2006, both of which are hereby incorporated herein by reference in their entirety.

### FIELD OF THE INVENTION

This invention relates to water purification, and in particular, to the use of electromagnetic fields for ameliorating bacteria in water.

### BACKGROUND

Legionellosis or Legionnaires' disease is a form of pneumonia brought about by the inhalation of bacteria from one or more species of the genus Legionella. Although not common in terms of total numbers of cases, Legionnaires' disease often occurs as outbreaks of numerous cases resulting in multiple fatalities. As such, Legionnaires' disease has attracted significant attention from scientific organizations, such as the US Center for Disease Control, the World Health Organization, and the health care community in general.

Legionnaires' disease results from the inhalation of Legionella bacteria. Other routes of exposure such as ingestion do not result in illness. The number or concentration of Legionella bacteria necessary to cause infection is not known. The susceptibility to infection varies widely between individuals. Young, elderly, and immune-compromised individuals are substantially more susceptible than the general population.

Legionella bacteria are present at low levels in nearly all natural waters. At temperatures below approximately 70° F., the bacteria multiply very slowly and are not considered a significant potential source of infection. At temperatures above about 140° F. Legionella bacteria also multiply slowly, which reduces the risk of infection. Thermal elimination of the risk of infection requires temperatures of approximately 160° F. Between approximately 70° F. and 140° F., Legionella bacteria interact with biofilm that is present on most wetted surfaces and microorganisms such as amoeba which are commonly found in the biofilm. Through a process known as amplification, Legionella bacteria multiply rapidly and may become more virulent than in the non-amplified condition. When these water and temperature conditions are associated with devices which produce mists or respirable droplets and are within the breathing zones of immune-compromised individuals, a significant risk of infection exists.

Outbreaks of Legionnaires' disease have been traced to a wide variety of sources. One significant potential source is hospital showers. In this situation Legionella containing respirable water droplets are sprayed directly into the breathing zones of individuals whose health is sometimes less than optimal. The presence of Legionella bacteria in the shower is attributable to the presence of small levels of Legionella bacteria in the cold potable water system and to the design of hospital hot water systems.

Legionella bacteria are resistant to chlorine and chlorine compounds at levels typically used in drinking water systems. This resistance permits a few bacteria to reach the hot water system of a hospital or any other type of building. In hospitals, and many other large buildings, the hot water systems are designed as loops in which hot water is continually circulated. This design minimizes the amount of water which stands in the piping system and guarantees that the time delay between turning on a hot water faucet and receiving hot water will never be more than a few seconds. Many building codes limit the temperature of the circulating water in order to prevent scalding. While the temperature limits vary with location, they are almost always within the temperature range for Legionella growth and amplification.

In addition to being favorable for the growth of Legionella bacteria, the circulating water temperatures are also favorable for the growth of other bacteria and higher forms of microscopic life such as amoeba. The growth of these life forms in the hot water system leads to the formation of a biofilm on the pipe walls. Typical levels of chlorination in the hot water system are not sufficient to kill the biofilm. Proper temperatures and ineffective biocidal control permit Legionella bacteria to thrive in the hot water circulating loop and permit its spread to the non-circulating portions of the system, e.g., faucets, showers, and system dead legs (portions of the piping system which are used irregularly or not at all).

A wide variety of continuously or intermittently applied treatment methods have been tried to resolve this problem. Many of these treatment methods are somewhat effective in addressing the Legionella bacteria problem but all have one or more significant shortcomings in effectiveness, safety, reliability, or economics. Some of the more common continuous treatment techniques (and their shortcomings) include:
High circulating water temperatures (prohibited by many building codes)
Chlorination (ineffective at standard dosages, higher doses problematic or prohibited)
Chlorine dioxide (expensive, difficult to maintain)
Copper silver electrodes (expensive, questionable effectiveness, organism resistance)

Some of the more common intermittent treatment techniques include:
Super chlorination (labor intensive, corrosive, objectionable odors)
High circulating water temperatures (labor intensive, scalding hazards)

Despite their limitations, chlorine dioxide, super chlorination and high circulating water temperatures are known to quickly kill Legionella bacteria, including those bacteria which are within the biofilm.

Irrespective of whether or not conditions in a body of water are favorable to the growth of Legionella bacteria, various types of water systems utilize non-chemical water treatment methods. Such water systems include air conditioning cooling towers.

Cooling towers are part of the equipment used to reject heat from buildings. The primary means for rejecting this heat is through the evaporation of water which is recirulated through the tower. In almost all instances, the circulating water is treated to prevent the buildup of scale on equipment surfaces, to control bacteria within the water, and to limit the corrosivity of the water to the materials of construction of the tower and associated equipment.

Water treatment is normally accomplished through the use of chemical scale inhibitors, biocides, and corrosion inhibitors. While potentially effective if properly controlled, these chemicals are generally hazardous to people and the environment. It is not reasonable to use these chemicals in potable water systems.

Non-chemical water treatment devices have existed for many years. These devices have seen limited use in cooling towers and have achieved varying degrees of success. The majority of these devices claim to treat one or more cooling water treatment problems, e.g., scale, bacteria, and corrosion. Most of these devices claim to treat water through the application of magnetic, electric, or electromagnetic fields.

Several classes of these devices (magnetic water treatment devices) exist. These include but are not limited to fixed magnets, electromagnets which generate low frequency fields, electromagnets which generate high frequency fields, electromagnets which generate interrupted electromagnetic fields, and electromagnets which create multiple or complex fields which may be a combination of the above described fields. Devices in these categories may generate electromagnetic fields through the use of induction coils and/or electrodes, which, when charged, act as capacitors and create electric fields. Induction coils and electrodes when used in this manner may be called “field generating devices.” The efficacy in treating water, especially in controlling bacteria, of these classes of devices is not equal. Although unequal, it is believed that, at least under certain operational conditions, all classes have the potential to clarify water, control scale, and/or limit bacteria.

Within roughly the last decade the sophistication of some of these devices as well as their records of success in treating cooling tower systems has increased. The most widely used device has been commercialized by Clearwater Systems of Essex, Conn., and is marketed under the trade name “Dolphin.” This device is disclosed in U.S. Pat. No. 6,063,267 as well as U.S. patent application Ser. No. 11/192,452, which are hereby incorporated herein in their entirety.

There are various reasons for not using non-chemical water treatment devices as stand alone devices in potable water systems. One reason is that until the last few years, the bactericidal performance of non-chemical water treatment devices was not fully sufficient, especially when starting with a contaminated system. When starting with a contaminated system, non-chemical devices do not instantaneously eliminate bacteria from the water system. This is particularly true of sessile bacteria which are included in biofilms. Operating independently, it may take several weeks for a non-chemical device to eliminate biofilms from the plumbing system. During this time, small sections of the biofilm will be sloughed off into the circulating water. Bacteria in these sections of biofilm will become dispersed (planktonic) in the water stream. In this planktonic form, the bacteria may exit the plumbing system through a faucet or showerhead and be inhaled by a person, thereby creating a risk of infection. Based on the forgoing reasoning, the independent use of non-chemical devices in recirculating, hot, potable water systems actually increases the legionnelosis hazard posed by such a system for a period of several weeks following the start of treatment.

Chemical or thermal treatments, in and of themselves, may not provide fully adequate treatment for recirculating, hot, potable, water systems. Chemical- and thermal-only water treatment programs typically suffer from one or more of the following problems: lack of long term effectiveness, high equipment costs, high labor costs, mechanical complexity, toxicity concerns, regulatory restrictions, and disruption of water service to building occupants.

### SUMMARY OF THE INVENTION

The present invention resides in a method for providing biological control to a flow of water in a recirculating potable hot water system. In such a system, water is recirculated through a loop connected to a water heater. The loop has at least one branch line that is connected to a delivery device such as a sink, shower, or the like. The water is subjected to an initial chemical treatment using an oxidizing biocide such as chlorine dioxide or peracetic acid that rapidly and effectively kills biofilm and/or Legionella bacteria. This treatment is continued until existing Legionella bacteria and biofilm are controlled. Once the bacteria and biofilm are controlled the chemical treatment is stopped. Starting concurrently with the chemical treatment or at the termination of the chemical treatment, non-chemical water treatment is provided. The non-chemical water treatment maintains the water system in a condition which is free of Legionella bacteria and biofilm. The non-chemical water treatment is maintained throughout the life of the water system. Chemical water treatment may be repeated intermittently should it prove desirable or necessary. Water treated in this manner provides rapid and continuing control of bacteria and biofilm at minimum cost and with minimum chemical hazard to those who use and maintain the water system.

The present invention also resides in an apparatus for providing biological control to a flow of water in a recirculating potable hot water system. In its largest sense, the apparatus consists of the hot water recirculating piping system, branch and makeup piping connected to that system, the water heating device, and a pump to circulate the water. The apparatus also includes the chemicals to be used in treatment as well as the chemical and non-chemical treatment equipment. The chemical to be injected will be an oxidizing biocide, preferably chlorine dioxide, or peracetic acid. The associated equipment will include pumps, tubing, and chemical storage or generation equipment. The apparatus also includes at least one non-chemical water treatment device and preferably at least two devices which are optimally located on the makeup and recirculating section of the piping system. The non-chemical device may be selected from any of several categories of devices but will preferably be an electromagnetic device. One or more control systems can be used to control the dosage of chemicals as well as operate the chemical system during the initial treatment period and during any desired subsequent treatment period and to operate the non-chemical device beginning either at the beginning of treatment or at the end of the initial chemical treatment and continuing for the life of the system.

### BRIEF DESCRIPTION OF THE DRAWINGS

FIG. 1 is a schematic representation of the circuitry of the preferred embodiment.

FIG. 2 is an oscilloscope trace showing a waveform representative of the preferred embodiment.

FIG. 3 is a schematic representational view of a recirculating hot water system that includes the chemical injection equipment and the non-chemical water treatment device.

### DETAILED DESCRIPTION OF THE INVENTION

This invention resides in the combination of technologies from various fields, namely, non chemical water treatment devices for utility water systems and bactericidal treatments for the control of Legionella bacteria in recirculating, hot, potable water systems. The invention comprises the combination of a non-chemical water treatment device with an intermittent chemical water treatment program for the purpose of controlling Legionella bacteria in a recirculating, hot, potable, water system.

To overcome the limitations in the treatment of recirculating, hot, potable, water systems for the purpose of controlling Legionella and other harmful bacteria of stand alone chemical and non-chemical water treatment programs, the invention, in its most basic form, comprises a method for the treatment of Legionella and other harmful bacteria in recirculating, hot, potable, water systems in which the water to be treated is subjected to treatment by an oxidizing biocide and a non-chemical water treatment device.

In this treatment method, the system is initially subjected to a chemical treatment, either with or without simultaneous treatment by the non-chemical device. The purpose of the chemical treatment is to rapidly kill all harmful planktonic and sessile bacteria in the system. The nature of the chemical used as well as its dose and the duration of the treatment is sufficient to accomplish the desired purpose. Once sufficient chemical treatment has been provided to eliminate harmful bacteria from the piping system, chemical dosing is terminated and can be selectively re-introduced as needed. If desired, the chemical treatment equipment is removed. Sufficiency of treatment may be determined by testing the water system for Legionella bacteria. The present invention is not limited in this regard, however, as other factors may contribute to the determination as to whether treatment should be continued. Also, the present invention is not limited to the use of chemical treatment with or without simultaneous non-chemical treatment, as a thermal treatment may also be incorporated into the methods described herein.

Following cessation of chemical treatment, the non-chemical device is then turned on or allowed to continue operating. The non-chemical device can then operate continuously for the life of the hot water system, or it can be used intermittently as desired.

It may be beneficial to periodically, based on either a schedule or the results of water tests, reconnect or reactivate the chemical treatment system to provide supplemental treatment. A periodic chemical retreatment once every six months may be appropriate for many water systems.

In another embodiment of the invention, the non-chemical water treatment device will be a magnetic treatment device. Also in this embodiment, the oxidizing biocide will comprise an oxidizing biocide which is highly effective in the treatment of, or the elimination of, biofilms. Two oxidizing biocides known for this property are chlorine dioxide and peracetic acid.

In a still more desirable form the invention, the non-chemical water treatment device will be a magnetic treatment device which will, through the use of a field generating device, generate at least one electromagnetic field and at least one of those fields will have a frequency of between 10 and 100 kHz and at least one of those fields will be periodically interrupted. The periodicity of the interruption of the field will be at least 1 Hz (one occurrence per second).

In the preferred embodiment of this invention, the non-chemical device will be one which treats water by way of electromagnetic fields. The device comprises a source of AC power (110-480 V, 50-60 Hz typically), a step down transformer (output voltage 13-40 V typically), switching circuitry, at least one induction coil, and some amount of capacitance, either in the form of a capacitor or as distributed capacitance, typically within the induction coil. The circuitry is connected so that when the switch or switches within the circuit are open an LCR (inductance capacitance resistance) circuit which is capable of resonating (ringing) at a characteristic frequency is formed. The coil(s) are placed around a section of non-metallic pipe through which the water to be treated flows such that when electric current flows through the coils electromagnetic fields are generated within the flowing fluid.

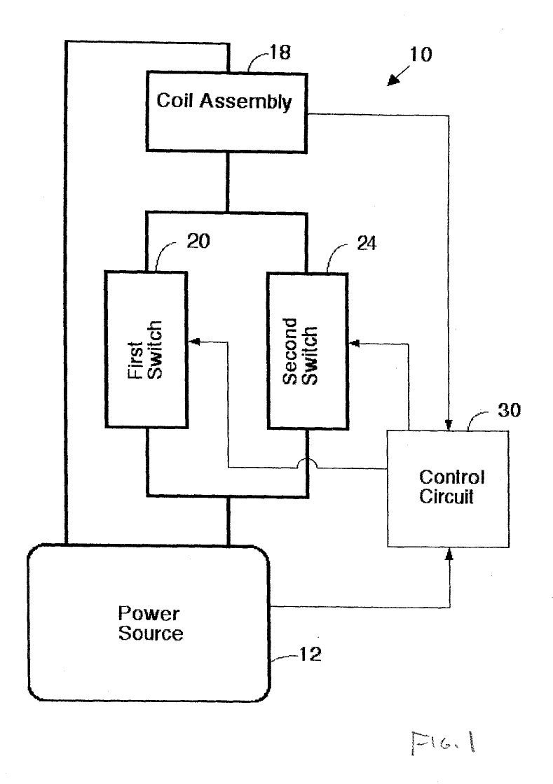

Referring to FIG. 1, a schematic representation of the circuitry of an apparatus of the preferred embodiment is shown generally at 10 and is hereinafter referred to as “apparatus 10.” The apparatus 10 is a pulsed power device capable of generating a ringing magnetic pulse for treating flowing liquids. The apparatus 10 comprises a power input source 12, a coil assembly 18, a first switch 20, a second switch 24, and a control circuit 30.

The coil assembly 18 can be characterized as having inductance and capacitance. The capacitance comprises the distributed capacitance inherent to the coil which may be supplemented by a capacitor. The first switch 20 comprises a triode switch which is capable of allowing current to pass in only one direction and only when “turned on” by a control signal. The first switch 20 is turned off by reversing the direction of the current through the switch. The second switch 24 comprises a triode switch which is generally capable of carrying current in only one direction and which is turned on and turned off by a control signal. The first and second switches may be selected from several categories of triode switches known to those skilled in the art. The control circuit 30 performs the functions of monitoring the power supplied by the power source 12 and by monitoring the electrical signal generated by the coil assembly 18. The control circuit 30 then performs the function of turning on the first switch 20 and turning on and off the second switch 24.

The electromagnetic field generating portion of the circuit is constructed by connecting a first lead of the power source 12 to a first lead of the first switch 20 and a first lead of the second switch 24. The second leads of the first switch 20 and the second switch 24 are connected to the first lead of the coil assembly 18, and the second lead of the coil assembly 18 is connected to the second lead of the power source 12. The control portion of the circuit comprises a variety of components in the control circuit 30 arranged so as to monitor the power supply 12 and the coil assembly 18 and to provide control signals to the third terminals of the first switch 20 and the second switch 24.

Electromagnetic water treatment fields are generated by the coil assembly 18 in response to the operation of first switch 20 and the second switch 24. Closing the first switch 20 causes the formation of a strong magnetic field within the coil assembly 18. Opening the first switch 20 causes ringing current of relatively high frequency and low amplitude to be formed in the coil assembly 18. Operating the second switch 24 causes a ringing current of relatively high frequency and high amplitude to be formed in the coil assembly 18.

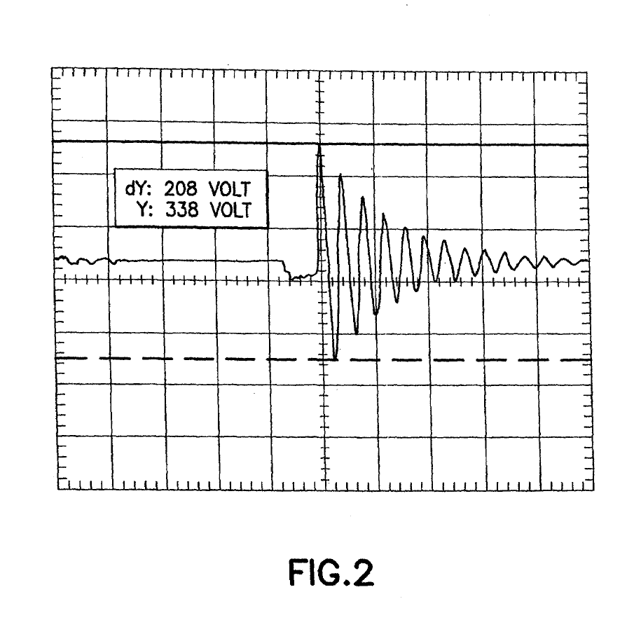

More specifically, the electromagnetic fields generated by the non-chemical device of the preferred embodiment (apparatus 10) are based on the frequency of the source of AC power (typically 50-60 Hz) and the resonant frequency of the LCR circuit formed by the induction coil(s) and capacitance. The generation of the electromagnetic fields proceeds as follows: When the voltage in the AC power supply crosses zero in a positive direction, the first switch closes. This allows a substantial current to flow to the induction coil(s) and, thereby, creates a strong, time varying magnetic field within the flowing water. Due to the inductance within the circuit, the current passing through the coils remains positive for about ¾ of the AC cycle. When this current drops to zero, the first switch is disconnected from the power supply. The voltage remaining within the circuit causes it to ring (resonate) at the resonant frequency of the circuit. In the case of the device in the preferred embodiment, the resonant frequency is typically between 10 kHz and 100 kHz. Once this ring has decayed, and still within a single cycle of the AC power source, the second switch is quickly connected to and then disconnected from the power source. The closing of this second switch provides power to the circuit. Thus, the second switch allows the power source to be disconnected from the rest of the circuit to cause the circuit to ring. The ring due to the operation of the second switch has the same frequency as the ring due to the primary switch but has a much larger amplitude (voltage), typically greater than 300 V peak to peak. Once this ring decays the second switch is operated again, creating another high amplitude ring. Depending on the characteristics of the circuit, the second switch may be operated 4 or more times within the AC power cycle. FIG. 2 is an oscilloscope trace showing a waveform representative of the preferred embodiment.

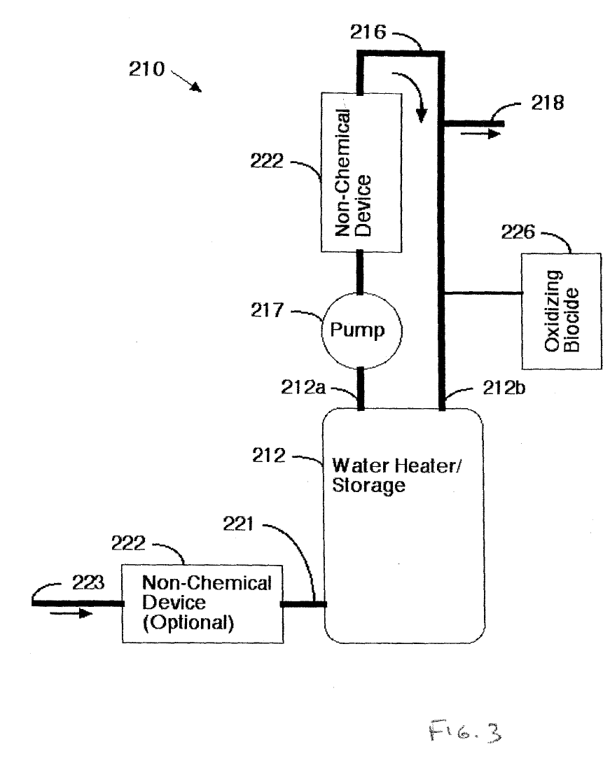

Referring now to FIG. 3, an apparatus for the control of microorganisms such as Legionella in recirculating hot potable water systems that includes chemical and non-chemical treatment equipment is shown generally at 210. The apparatus 210 includes piping 216 through which the recirculating hot water flows (a recirculating loop), at least one non-chemical water treatment device 222, equipment 226 for making or storing an oxidizing biocide and introducing it into the water system, and a water heating and storage device 212 having an outlet 212a to the piping 216 and an inlet 212b from the piping 216. Optionally, the water heating and storage device may be separate devices or the water storage device may be omitted. A pump 217 can also be included to circulate water. At least one water delivery device 218, such as a sink or shower, is in fluid communication with the piping 216 and provides an outlet through which hot water may exit the system to a user. A cold water piping system 221 from a water source 223 can also be included to provide makeup water to the hot water system. A non-chemical treatment device 222 may optionally be included in the makeup water system.

Those skilled in the art will recognize that the arrangement of components of the piping system can vary considerably without affecting the operation of the system. Several potential variances from FIG. 3 are of particular note. The existence of a hot water tank is optional. The chemical injection equipment may be permanently installed or connections may be supplied such that the chemical injection equipment may be removed from the system when not in use and reinstalled should its use be desired at a later date. One non-chemical treatment device may be installed at any point in the recirculating loop. Alternately, although less desirably individual non chemical treatment devices may be installed on all the connections, e.g., showers or sinks, to the piping system. Although not essential to the operation of the system, it is desirable to install a second non-chemical device on the makeup line to the hot water system.

Use of the invention will accrue the benefits of improved treatment efficacy, reduced treatment costs, and reduced hazards to maintenance workers as compared to current treatment methods.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. An apparatus for the control of microorganisms in a recirculating hot potable water system, said apparatus comprising:
a piping system, comprising:
a water makeup line;
a water heating device;
a loop for the recirculation of hot water;
a pump for recirculating hot water;
at least one water delivery device which supplies water to a user;
at least one non-chemical water treatment device, said non-chemical water treatment device being located so as to treat water in the recirculating hot water loop;
at least one chemical water treatment system, said chemical water treatment system including,
an oxidizing biocide; and
equipment to inject said oxidizing biocide into the hot potable water system; and
wherein the chemical treatment equipment is operable at an onset of treatment and selectively operable thereafter; and
wherein the non-chemical device is operable at any time between the onset of treatment and a cessation of an initial period of chemical treatment and is selectively operable thereafter.

2. The apparatus of claim 1, wherein the oxidizing biocide is chlorine dioxide.

3. The apparatus of claim 1, wherein the oxidizing biocide is peracetic acid.

4. The apparatus of claim 1, wherein said non-chemical water treatment device comprises,
a conduit within which water to be treated is contained as it passes therethrough,
at least one field generating device placed around said conduit,
a source of electrical power connected to said at least one field generating device, and
electrical components which, when connected to said source of power and to said at least one field generating device, create at least one electromagnetic field within said water as it passes through said field generating device.

5. The apparatus of claim 4, wherein at least one of said at least one electromagnetic fields has a frequency of about 10 kHz to about 100 kHz.

6. The apparatus of claim 4, wherein at least one of said at least one electromagnetic field is intermittent and wherein the frequency of the interruption of the field is at least one time per second.

7. The apparatus of claim 6, wherein said intermittent electromagnetic field is formed by using a switching device to alternately allow and prevent current from flowing between said source of electrical power and said at least one field generating device.

8. The apparatus of claim 7, wherein a ringing electromagnetic field is formed during at least a portion of the time that the current which flows between said source of electrical power and at least one induction coil is blocked by said switching device.

9. A method for the control of microorganisms in recirculating hot potable water systems, said method comprising the steps of:
providing a piping system through which water to be treated may be circulated,
said piping system including:
a cold water makeup line;
a water heating device;
a loop for the recirculation of hot water;
a pump for recirculation of hot water; and
at least one water delivery device which supplies water to a user;
selectively providing an initial chemical treatment using an oxidizing biocide to said water in said piping system; and
selectively providing a non-chemical water treatment to said water in said piping system.

10. The method of claim 9, wherein the oxidizing biocide is chlorine dioxide.

11. The method of claim 9, wherein the oxidizing biocide is peracetic acid.

12. The method of claim 9, wherein said non-chemical water treatment device comprises,
a conduit within which said water to be treated is contained as said water passes therethrough,
at least one field generating device placed around said conduit,
a source of electrical power; and
electrical components which, when connected to said source of power and to said at least one field generating device, create at least one electromagnetic field within said water as said water passes through said field generating device.

13. The method of claim 12, wherein at least one of said at least one electromagnetic fields has a frequency of about 10 kHz to about 100 kHz.

14. The method of claim 12, wherein at least one of said at least one electromagnetic fields is intermittent and wherein the frequency of the interruption of the field is at least one time per second.

15. The method of claim 14, wherein said intermittent electromagnetic field is formed by using a switching device to alternately allow or prevent current from flowing between said power source and said at least one field generating device.

16. The method of claim 15, wherein a ringing electromagnetic field is formed during at least a portion of the time that the current which flows between the power supply and at least one induction coil is blocked by said switching device.

17. The method of claim 9, further comprising killing an effective portion of Legionella bacteria in said hot water.
